(19) United States
(12) Patent Application Publication
(10) Pub. No.: US 2009/0325544 A1
(43) Pub. Date: Dec. 31, 2009

(54) METHOD FOR SCREENING AND RETRIEVING UNANSWERED MOBILE CALLS THAT FORWARD TO VOICE MAIL

(76) Inventors: Douglas Anthony Deutsch, Naperville, IL (US); Keith R. Stanley, Warrenville, IL (US); A. Larry Wierzbicki, Bolingbrook, IL (US)

Correspondence Address: FAY SHARPE/LUCENT, 1228 Euclid Avenue, 5th Floor, The Halle Building, Cleveland, OH, 44115-1843, US

(21) Appl. No.: 12/164,748

(22) Filed: Jun. 30, 2008

(51) Int. Cl. H04M 3/42

(52) U.S. Cl. 455/413; 455/417

(57) ABSTRACT

A system and method for screening and retrieving unanswered mobile calls that are forwarded to voicemail systems is disclosed. The method includes connecting a call between a caller and a subscribers wireless phone and opening a connection between the caller and the subscribers wireless phone's voicemail system where the voicemail system is configured to facilitate a recording. The method continues with providing a line with a transmission path and a reception path between the subscriber and the voicemail system and offering a plurality of selectable options including allowing the subscriber to listen to the recording in real time.

### BACKGROUND OF THE INVENTION

This disclosure relates to a method and apparatus for screening and retrieving unanswered mobile calls that are forwarded to voice mail. More particularly, this disclosure relates to a method and system for screening and retrieving unanswered calls directed towards wireless mobile units.

While this disclosure is particularly directed to screening and connecting mobile calls that have been forwarded voice messaging systems, and will be thus described with specific reference thereto, it will be appreciated that the disclosure may have usefulness in other fields and applications. For example, this disclosure may be used for screening calls in other types of telephony networks.

By way of background, it is well known that answering machines have been used in order to screen messages for wired telephone systems. Subscribers to these wired systems have the capability to listen in on the individuals leaving messages on their answering machines without physically answering the telephone call themselves. Generally, when a call comes into a wired system that is associated with an answering machine, a user may listen to the message in real time as it is being left by the caller. All the user must do is stand within close enough proximity to the answering machine in order to hear the message as it is being recorded. The user also has the option to pick up the line in order to speak directly with the calling party.

Mobile devices, however, do not have built in answering machines. This is at least in part because mobile devices are highly portable while answering machines are not. Instead, wireless systems generally have access to voice messaging systems. These systems are usually within the communication network. As such, mobile subscribers generally cannot hear the calling party as a message is being recorded. In this form, the mobile subscriber cannot “barge-in” on the call if they determine, subsequent to forwarding, that they would like to speak to the calling party. This prevents a mobile subscriber from screening calls based on the calling party and their message. It may also be a nuisance to wait until the message is recorded before retrieval is possible. This problem is compounded by the fact that it takes time to get the calling party's number and place a new call to the calling party.

Therefore, there is a need in the industry for a system and method that allows a subscriber to listen to a message being recorded on a voice mail system. It would also be useful for this system to give a subscriber options on how to handle the call once the subscriber has signaled an interest in the voice message. It would be useful if the system would allow a subscriber to “barge-in” on the call and continue recording, or erase the message once the call has been disconnected.

The present disclosure contemplates a new method and apparatus that resolves the above-referenced difficulties and other.

### SUMMARY OF THE INVENTION

A method and apparatus for a call processing system is provided. This disclosure will allow for a method of retrieving the forwarded call from a voice messaging server and connecting a receiving path and/or speech path to continue the conversation while the calling party is leaving a message. This disclosure will allow for a subscriber to “barge-in” to a recording without redialing the calling party. The method will also allow for continuing or suspending of the recording in the voice messaging system.

In one aspect of the disclosure a method for screening and retrieving unanswered mobile calls that forward to voice mail comprises connecting a call between a caller and a subscriber's wireless phone, opening a connection between the caller and the subscriber's wireless voice mail system where the subscriber's wireless voicemail system is configured to facilitate a recording. The method continues with providing a connection with a transmission path and a reception path between the subscriber and the voice mail system and offering a plurality of selectable options, including allowing the subscriber to listen to the recording in real time.

In accordance with another aspect of the present disclosure, the method includes that the plurality of selectable options includes a “barge-in” to transmit and receive while continuing to record the call.

In accordance with another aspect of the present disclosure, the method includes that the plurality of selectable options includes a “barge-in” to transmit and receive while ending the recording.

In accordance with another aspect of the present disclosure, the method includes that the plurality of selectable options includes an option that allows the subscriber to stop listening/screening the call while continuing with the recording or to terminate the call and the recording.

In accordance with another aspect of the present disclosure, the method includes that one of the plurality of selectable options includes deleting the recording.

In accordance with another aspect of the present disclosure, the method includes that providing the connection between the subscriber and voice mail system includes connecting the reception path and not connecting the transmission path.

In accordance with another aspect of the present disclosure, the method further includes authenticating the wireless phone line.

In accordance with another aspect of the present disclosure, the method includes playing a greeting associated with the subscriber's voice mail system.

In accordance with another aspect of the present disclosure, a system for screening and retrieving unanswered mobile calls that are forwarded to a voicemail system comprises a call processing logic module configured to facilitate in call processing for a call directed to a subscriber's wireless phone line. The system further includes a mobility access management module adapted to enable the call to access a wireless basestation and connect to a voice messaging system. The system further includes a bearer handling module configured to control the bearer path associated with the call and a network interconnect configured to open a connection between the wireless basestation and the voice messaging system where the connection is connected to allow a subscriber to listen to the call while the call is connected to the voice messaging system.

In accordance with another aspect of the present disclosure, the system includes that the call has a transmission path and a receiving path where the transmission path is connected and the receiving path is disconnected.

In accordance with another aspect of the present disclosure, a system for call screening in a wireless network includes a voice messaging service associated with a wireless subscriber's line that is operable to create a recording of the line and a mobile switching center configured to receive a call having a receiving path and a transmission path to the wireless service subscriber's line, forward the call to a voice messaging service, open a connection between the voice messaging system and the wireless subscriber's line and offer a plurality of selectable service options including facilitating a line for the subscriber to listen to the recording in real time.

In accordance with another aspect of the present disclosure, a system for directing the screening mobile to disconnect the transmit path, preventing the screening party from being heard by the calling party during screening.

### DESCRIPTION OF THE DRAWINGS

The presently described embodiments exist in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 illustrates a portion of the overall communications network including a subscriber's wireless line, Mobile Switching Center (MSC) and voicemail server.

FIG. 2 is a flow chart illustrating the overall method according to the present disclosure.

FIG. 3 illustrates one embodiment of modules that may be used in accordance with the present disclosure.

### DETAILED DESCRIPTION

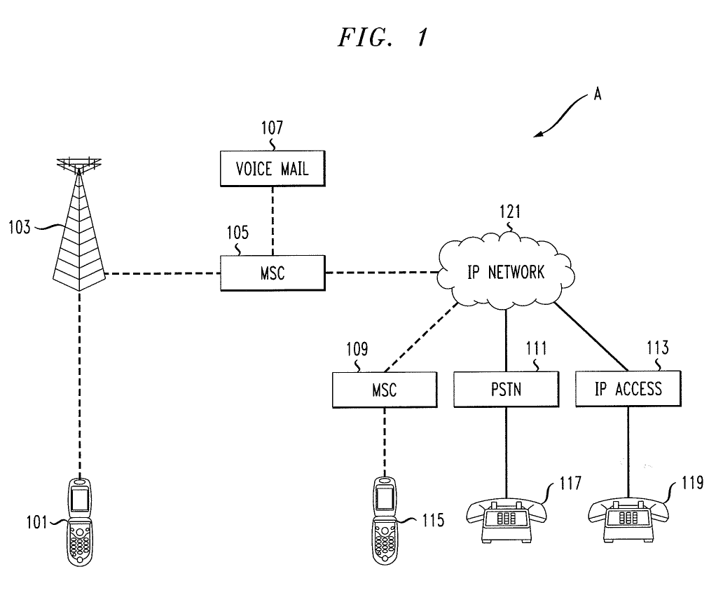

Referring now to the drawings which are shown for purposes of illustrating the disclosed embodiments of the disclosure only and not for purposes of limiting the same. FIG. 1 illustrates an overall view of the system to which the present disclosure may be incorporated. The communications infrastructure A is shown. The communications network infrastructure A includes a subscriber's mobile unit 101, a base station 103, a first MSC 105, a voice mail server 107, a second MSC 109, a Public Switched Telephone Network (PSTN) 111, and a Internet Protocol (IP) access module 113. The system also includes a calling party's mobile unit 115 and calling party's Plain Old Telephone Service (POTS) telephone 117, a calling party's Voice over Internet Protocol (VoIP) telephone 119 and the IP network 121. It should be understood that this represents but one embodiment of the communications network infrastructure. The present disclosure could be incorporated in a variety of communication networks configurations.

In operation, as described in greater detail below, the presently described embodiments include a method for screening and retrieving unanswered mobile calls that are forwarded to voicemail. The method includes notifying a mobile call processing system that the mobile subscriber wants to listen as the voice message is being recorded. The disclosed method includes retrieving the forwarded call from the voice messaging system and connecting a speech path to join the conversation while the called party is leaving the message, without redialing the calling party's number. The method will also include options for continuing or suspending the recording of the calling party's message. The method may also include an option of deleting the called party's message upon disconnecting the calling party. This disclosure will allow a service provider to offer enhanced service to subscribers. This service may be a free based application allocated on a pre or post paid subscription plan. The service may also use allocated minutes for this purpose.

Still referring to FIG. 1, the subscriber's mobile unit 101 could be associated with a variety of different communication devices, including but not limited to, wireless phones and Personal Digital Assistance (PDA). These end devices are typically consumer premise equipment used to communicate through compatible wireless lines. The subscribers mobile unit 101 is used in order to connect to corresponding network elements.

The subscribers mobile unit 101 in communication with a basestation tower 103. The basestation tower 103 is in turn in communication with the first MSC 105. The MSC 105 is in communication with the voicemail server 107 and the IP network 121. In another embodiment, the mobile subscriber is roaming and the voice messaging system 107 may not have a direct connection with the MSC 105. In this case, the connection may take place elsewhere in the network. It should be noted that the IP network 121 may also be a TDM network. The connection to the voicemail server 107 may be via TDM or another IP facility.

A calling party may use a variety of means in order to attempt to establish a connection with the subscriber. One such method is another mobile unit 115. The mobile unit 115 is in communication with a second MSC 109. Another method of communication by a calling party is to use a POTS telephone 117, which is in communication with a PSTN 111. A third option is a VoIP phone 119 which may be in communication through an IP access server 113. Other methods which are known in the art may also be used in order to contact a wireless subscriber.

In one embodiment of this disclosure, the calling party attempts to call the subscribers mobile unit 101 through either their wireless mobile unit 115, their POTS telephone 117, or their VoIP telephone 119. The call is forwarded through the IP network 121 to the first MSC 105. The subscribers mobile unit 101 is alerted and once a predetermined time interval passes, the call is connected to the voice message server 107. The voice message server 107 is then configured to play an optional, a pre-recorded greeting, for the calling party, after which the calling party is prompted to leave a message while the voice mail server 107 creates a recording.

The MSC 105, in one embodiment, is configured to offer choices which enable the called party to listen in as the recording is being created. In another embodiment, the call path may include elements from an IMS network which controls the call and directs the MSC 105 to offer choices to the mobile subscriber. One of the options includes monitoring the reception path of the call while the transmission path is not connected. This will enable the subscriber to listen to the message as it is being recorded while the subscriber's line is muted. In embodiments that avoid connecting the transmission path, certain air interface and backhaul resources can be saved. This will, in turn, provide additional capacity for other subscribers and create incremented revenue generation in the same air interface.

After the reception path is connected, the MSC may offer choices including allowing the subscriber to continue to listen. Another selection option includes connecting the transmission path, enabling the subscriber to “barge in” on the message while the recording is continuing to take place. Another embodiment includes connecting the transmission path and ending the recording by the voicemail server 107. In yet another embodiment, an option allows for the reception path to be disconnected while the voicemail server 107 continues to record. In yet another embodiment, one of the choices includes terminating the call and terminating the recording. Another embodiment gives the subscriber the option of keeping or deleting the recording.

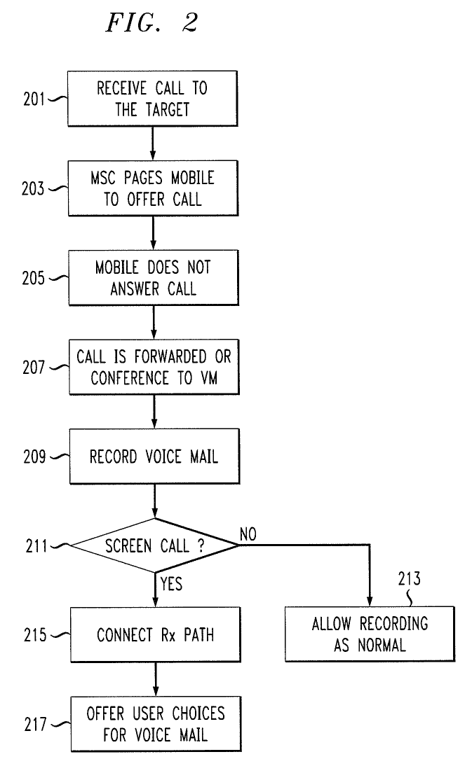

Now referring to FIG. 2, a method of screening and retrieving unanswered mobile calls is shown. The method begins with receiving a call to the target (at step 201). The call will generally originate from the calling party's means of communication. This may include a VoIP phone 119, a POTS phone 117, a wireless phone 115, etc. Each of these lines of communication may have their own method of communicating with the wireless network. However, generally the call will be received by an MSC 105.

The method continues with the MSC 105 paging the subscriber's (target) mobile unit 101 (at step 203). The page will, in some embodiments, cause the subscriber's mobile unit 101 to ring, vibrate, etc. However, in other embodiments the call will be forwarded directly to the voicemail system 107 depending on the status of the subscribers' mobile unit 101 at the time of the call.

The method continues with the subscribers' mobile unit 101 ignoring/not answering the call (at step 205). The subscriber's mobile unit may not answer the call for a variety of reasons. In one embodiment, the mobile unit 101 is in a status where all calls go directly to the voicemail server 107. In another embodiment, subscribers mobile unit 101 is geographically in an area that does not allow service. In yet another embodiment, the subscribers mobile unit 101 has an offered the call for a minimum threshold of time and the call is, in turn, denied after that threshold has been met. In another embodiment, the mobile unit 101 is geographically in an area that does not allow service. However, the customer may be in that area temporarily. If the mobile exits the area while message is being left, this service could enable this call to complete where it would not have otherwise completed. In this form, the called party may have the opportunity to accept a forwarded call thus improving customer service. In another embodiment the MSC is directing all calls to the voicemail server 107.

The method continues (at step 207) with the call being forwarded or conferenced to the voicemail server 107. Generally, the method continues with the voicemail server 107 recording the call (at step 209).

The next step in the method (at step 211) involves the subscriber being prompted as to whether the subscriber would like the call screened (at step 211). The prompt may take place in one embodiment by the subscriber using the mobile in order to signal to the MSC 105 while the call is being recorded. If the subscriber does not want the call to be screened, the recording would continue as normal (at step 213).

The method continues, if the subscriber would like the call screened, with connecting the receiving path (at step 215). Once the receiving path is connected, the subscriber will generally be able to hear the recording in real time. However, without the transmission path being connected, the calling party will not be signaled that the call is being screened.

The method continues with offering the user choices on how to continue with the voicemail (at step 217). These choices may include a “barge-in” option while continuing to record the call. Another option may include a “barge-in” option that ends the recording. Another option may include that the subscriber drops the connection, e.g., disconnects the receiving path while the voicemail server 107 continues to record. Another option may include terminating the call while continuing the recording. Another option may include deleting the recording at the termination of the call. These options may all be selectable by a variety of means, including, but not limited to, voice recognition, hard key, soft key, etc.

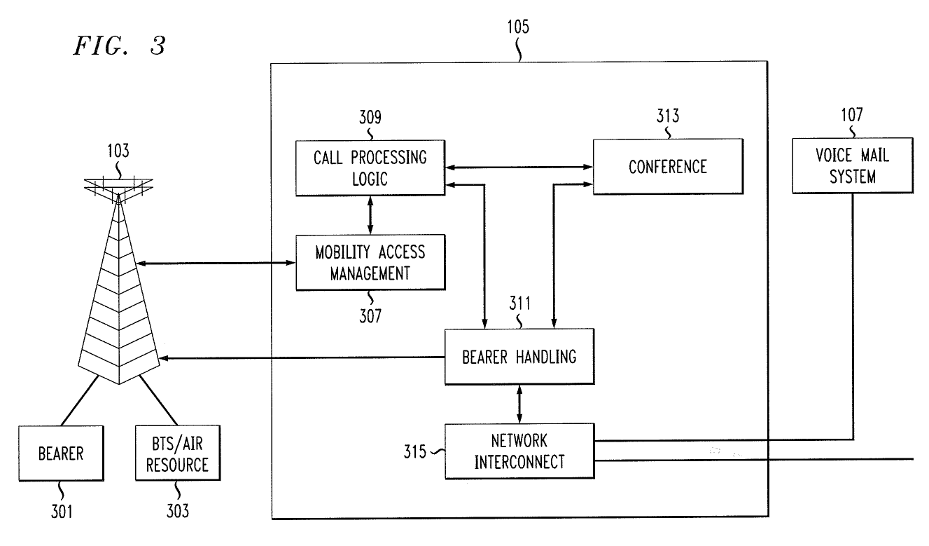

Now referring to FIG. 3, which shows one embodiment of the module configuration related to the MSC 105. The modules include mobility access management module 307, a call processing logic module 309, a bearer handling module 311, a conferencing module 313, and a network interconnect module 315. The system also includes a base station 103, which is configured to process a bearer path 301 and a base station air resource 303. It should be understood that this represents but one embodiment of the MSC 105. These modules may be connected and in communication with each other through a variety of methods. Furthermore, multiple modules may be used in association with a variety of functions. These modules may also be represented in a variety of network elements and spread throughout the network communications system.

In operation, a call may be received through the network interconnect 315. The network interconnect 315 is configured to open a connection between the wireless base station 103 and the voice messaging system 107 where the connection is connected to allow a subscriber to listen to the call while the call is connected to the voice messaging system 107. However, when a call is received from the network interconnect 315, it is generally sent through the bearer handling module 311 and to an associated base station 103 in order to alert a subscribers mobile unit 101.

If the call is not answered, the mobility access management module 307 may alert the call processing logic module 309 and the conferencing module 313 in order to forward the call through the network interconnect 315 to the voicemail system 107. In this form, the voicemail system may then proceed to play a greeting for the calling party.

If the subscriber desires to exercise one of these selectable options for screening and/or retrieving the unanswered mobile call that has been forwarded to the voicemail system 107, the desire will be signaled through the base station 103 along the bearer path 301. Once the mobility access management module 307 receives the signal along the bearer path 301, a conference may be set up through the conferencing module 313 and/or the network interconnect 315 which links the receiving path of the subscribers line to the voicemail system 107. In this form, the subscriber is capable of screening the call without the calling party being alerted.

The system may also allow for selectable options to be offered to the subscriber which will allow for the subscriber to have the transmission path connected while the voicemail system 107 is recording. Furthermore, a selectable option could include that the recording ends once the transmission path is connected. Another option may include that the subscriber drop the call, e.g., receiving path while the call continues to record on the voicemail system 107. Another selectable option may include terminating the call and the recording. These options may be managed through the mobility access management module 307 while selection choices are received along the bearer path 301 from the subscribers mobile unit 101.

The above description merely provides a disclosure of particular embodiments of the invention and is not intended for the purposes of limiting the same thereto. As such, the disclosure is not limited to only the above-described embodiments. Rather, it is recognized that one skilled in the art could conceive alternative embodiments that fall within the scope of the disclosure.

We claim:

1. A method for screen and retrieving unanswered mobile calls that forward to voice mail comprising:
connecting a call between a caller and a subscriber's wireless phone;
opening a connection between said caller and said subscriber' wireless phone voice mail system where the voice mail system is configured to facilitate a recording;
providing a connection with a transmission path and a reception path between said subscriber and voicemail system; and
offering a plurality of selectable options including allowing the subscriber to listen to the recording in real time.

2. The method according to claim 1 wherein said plurality of selectable options includes a barge-in while continuing to record said call option.

3. The method according to claim 1 wherein said plurality of selectable options includes a barge in option that ends said recording.

4. The method according to claim 1 wherein said plurality of selectable options includes an option that allows the subscriber to drop said connection while continuing with said recording.

5. The method according to claim 1 wherein said plurality of selectable options includes an option to terminate said call and said recording.

6. The method according to claim 1 wherein said plurality of selectable options includes deleting said recording.

7. The method according to claim 1 wherein said providing said line between the subscriber and voicemail systems includes connecting said reception path and disallowing said transmission path.

8. The method according to claim 1, further comprising authenticating the wireless phone line.

9. The method according to claim 1, further comprising playing a greeting associated with said voice mail system.

10. The method according to claim 1, further comprising billing the subscriber for invoking the screening and barge in features.

11. The method according to claim 1, further comprising billing the subscriber for the airtime usage during screening of recordings and continuing to bill for usage during barge in.

12. A system for screening a retrieving unanswered mobile calls that forward to a voicemail system comprising:
a call processing logic module configured to facilitate in call processing of a call directed to a subscriber's wireless connection;
a mobility access management module adapted to enable said call to access a wireless base station and connect to a voice message messaging system;
a bearer handling module configured to control the bearer path associated with said call; and
a network interconnect configured to open a connection between said wireless base station and said voicemail messaging system where said connection is connected to allow a subscriber to listen to the call while said call is connected to the voice messaging system.

13. The system according to claim 12 where said path includes a transmission path and a receiving path.

14. The system according to claim 13 where said transmission path is connected and said receiving path is disconnected.

15. A system for call screening in a wireless network comprising:
a voice messaging service associated with a wireless subscriber's line that is operable to create a recording of said line; and
a mobile switching center configured to receive a call having a receiving path and a transmit path to said wireless service subscriber's line, forward said call to said voice messaging service, open a connection between said voice messaging system said wireless subscriber's line, and offer a plurality of selectable service options including facilitating a line for the subscriber to listen to the recording in real time.

16. The system according to claim 15 wherein facilitating a line for the subscriber to listen includes engaging said receiving path as said call is connected to the voice messaging service.

17. The system according to claim 15 wherein facilitating a line for the subscriber to listen includes disengaging said transmission path.

18. The system according to claim 15 wherein selectable options includes a barge-in while continuing to record said call option where said transmit path is engaged.

19. The system according to claim 15 wherein selectable options includes a barge-in option that ends said recording.

20. The system according to claim 15 wherein selectable options includes an option that allows the subscriber to drop said connection while continuing said recording.

21. The system according to claim 15 wherein selectable options includes saving said recording.

22. The system according to claim 15 wherein selectable options includes deleting said recording.

23. The system according to claim 15 wherein a path established to a called mobile, instructs said mobile to disconnect the transmit path from a microphone associated with said mobile, preventing the calling party from hearing the called party during screening.

24. The system according to claim 23 further comprising a mobile configured to transmit the minimum packet required to remain connected to the mobile switching center for screening, minimizing the use of the Air interface and transport bandwidth during the screening process.
